(19) United States
(12) Patent Application Publication
(10) Pub. No.: US 2019/0357197 A1
(43) Pub. Date: Nov. 21, 2019

(54) Method And Apparatus For Handling Out-Of-Order Scheduling In Mobile Communications

(71) Applicant: MediaTek Singapore Pte. Ltd., Singapore (SG)

(72) Inventors: Abdellatif Salah, Cambridge (GB); Ahmet Umut Ugurlu, Cambridge (GB); Xiu-Sheng Li, Hsinchu City (TW); Chung-Kang Liu, Hsinchu City (TW)

(21) Appl. No.: 16/412,396

(22) Filed: May 14, 2019

Related U.S. Application Data
(60) Provisional application No. 62/671,491, filed on May 15, 2018.

(51) Int. Cl. H04W 72/04; H04W 72/12; H04L 5/00

(52) U.S. Cl. CPC H04W 72/048; H04W 72/1294; H04L 5/0055; H04W 72/0446; H04W 72/1247

(57) ABSTRACT

Various solutions for handling out-of-order scheduling with respect to user equipment and network apparatus in mobile communications are described. An apparatus may receive a downlink control information (DCI) from a network node. The apparatus may detect whether an out-of-order scheduling is configured by the DCI. The apparatus may determine not to process the out-of-order scheduling in an event that the out-of-order scheduling is configured.

### CROSS REFERENCE TO RELATED PATENT APPLICATION(S)

The present disclosure is part of a non-provisional application claiming the priority benefit of U.S. Patent Application No. 62/671,491, filed on 15 May 2018, the content of which is incorporated by reference in its entirety.

### TECHNICAL FIELD

The present disclosure is generally related to mobile communications and, more particularly, to handling out-of-order scheduling with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR) Release 15, time-domain resource assignment (TD-RA) framework supports a KO parameter that allows a scheduling grant (e.g., DCI format 1_0 or 1_1) to schedule a physical downlink shared channel (PDSCH) transmission on a different slot. NR Release 15 also supports the type-B resource allocation wherein a scheduling grant can schedule a PDSCH within the same slot but starting from any other symbol than the 2^{nd} or 3^{rd} symbol of the slot. Such flexibility in NR TD-RA framework may introduce some advantages.

However, out-of-order scheduling between the scheduling physical downlink control channel (PDCCH) and scheduled PDSCH can be problematic from user equipment (UE) implementation perspective and it will involve additional implementation cost. A UE will need more resources (e.g., hardware/software components, power consumption, processing time, etc.) to process the out-of-order scheduling. There is no benefit to support the described out-of-order scheduling in some scenarios. For example, a scenario when supporting out-of-order scheduling could be useful is when the UE supports ultra-reliable and low latency communications (URLLC) and enhanced mobile broadband (eMBB) traffics simultaneously. Not supporting out-of-order scheduling in such scenario may penalize the URLLC traffic in terms of latency in an event that the eMBB traffic is already scheduled. Other than such scenario, there is no benefit to support the out-of-order scheduling.

Accordingly, whether to support the out-of-order scheduling may become a new issue in the newly developed communication system. It is needed to provide proper schemes for handling the out-of-order scheduling to reduce UE implementation cost and improve processing efficiency.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to handling out-of-order scheduling with respect to user equipment and network apparatus in mobile communications.

In one aspect, a method may involve an apparatus receiving a downlink control information (DCI) from a network node. The method may also involve the apparatus detecting whether an out-of-order scheduling is configured by the DCI. The method may further involve the apparatus determining not to process the out-of-order scheduling in an event that the out-of-order scheduling is configured.

In one aspect, a method may involve an apparatus determining whether an out-of-order scheduling is supported. The method may also involve the apparatus transmitting a capability indication to a network node according to a determination result. The method may further involve the apparatus determining whether to process an out-of-order scheduling according to the determination result.

In one aspect, an apparatus may comprise a transceiver capable of wirelessly communicating with a network node of a wireless network. The apparatus may also comprise a processor communicatively coupled to the transceiver. The processor may be capable of receiving, via the transceiver, a DCI from a network node. The processor may also be capable of detecting whether an out-of-order scheduling is configured by the DCI. The processor may further be capable of determining not to process the out-of-order scheduling in an event that the out-of-order scheduling is configured.

In one aspect, an apparatus may comprise a transceiver capable of wirelessly communicating with a network node of a wireless network. The apparatus may also comprise a processor communicatively coupled to the transceiver. The processor may be capable of determining whether an out-of-order scheduling is supported. The processor may also be capable of transmitting, via the transceiver, a capability indication to a network node according to a determination result. The processor may further be capable of determining whether to process an out-of-order scheduling according to the determination result.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting example scenarios under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling out-of-order scheduling with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR Release 15, time-domain resource assignment framework supports a KO parameter that allows a scheduling grant (e.g., DCI format 1_0 or 1_1) to schedule a PDSCH transmission on a different slot. NR Release 15 also supports the type-B resource allocation wherein a scheduling grant can schedule a PDSCH within the same slot but starting from any other symbol than the 2^{nd} or 3^{rd} symbol of the slot. Such flexibility in NR TD-RA framework may introduce some advantages. For example, the time gap between a PDCCH and a corresponding PDSCH allows relaxed UE processing timeline. The time gap can also allow enough preparation time for bandwidth part (BWP) switch for UE. The time gap also enables the network to assign any time-domain resources for a UE independently of the configured CORESET monitoring periodicity. As opposed to LTE where PDCCH can be positioned within the first 3 symbols of every sub-frame, NR supports flexible/configurable monitoring periodicity for PDCCH. Such configurability allows reduced UE power consumption. The flexibility in NR TD-RA allows the network to schedule PDSCH in any slot even if the monitoring periodicity for PDCCH is greater than one slot.

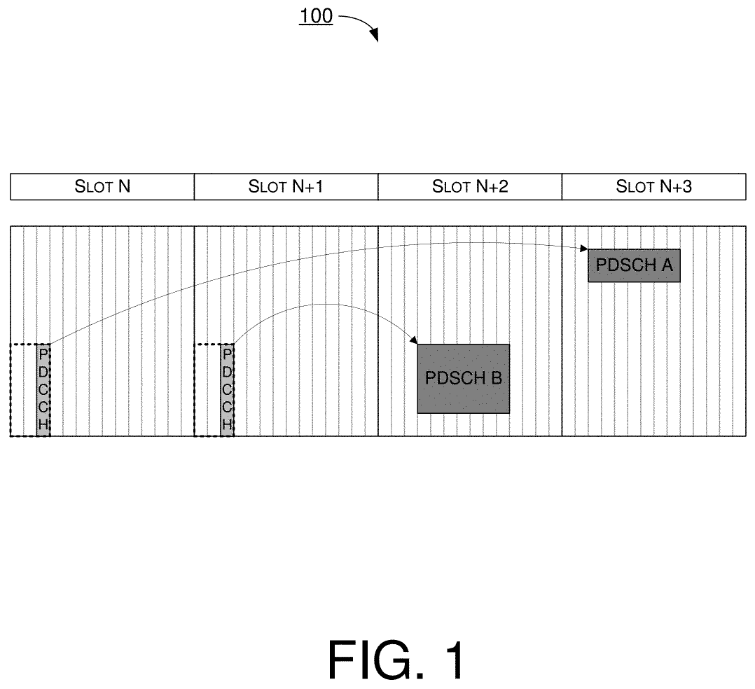

However, such flexibility in NR TD-RA framework also implies that a later arriving PDCCH can schedule a PDSCH transmission on earlier symbols than another PDSCH which has already been scheduled by another earlier PDCCH. FIG. 1 illustrates an example scenario 100 under schemes in accordance with implementations of the present disclosure. Scenario 100 involves a UE and a network node, which may be a part of a wireless communication network (e.g., an LTE network, an LTE-Advanced network, an LTE-Advanced Pro network, a 5G network, an NR network, an IoT network or an NB-IoT network). Scenario 100 illustrates an example of out-of-order scheduling across slots. The first PDCCH in slot #N schedules PDSCH A in slot #N+3. The later PDCCH in slot #N+1 schedules PDSCH B in slot #N+2. The PDSCH order across slots is not equivalent to the PDCCH order.

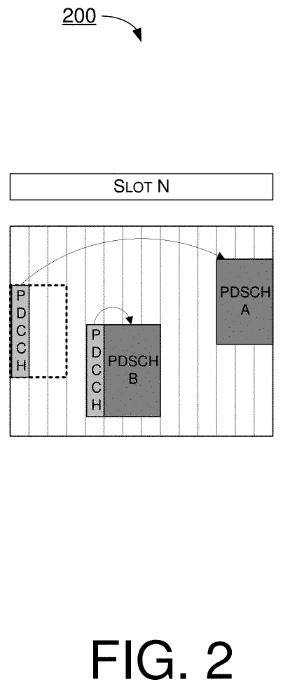

FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network or an NB-IoT network). Scenario 200 illustrates an example of out-of-order scheduling within a slot. The first PDCCH in slot #N schedules PDSCH A in symbols 12, 13 and 14 in the same slot. The later PDCCH in slot #N schedules PDSCH B in symbols 6, 7 and 8 in the same slot. The PDSCH order within the slot is not equivalent to the PDCCH order.

Out-of-order scheduling between the scheduling PDCCH and scheduled PDSCH can be problematic from UE implementation perspective and it will involve additional implementation cost. A UE will need more resources (e.g., hardware/software components, power consumption, processing time, etc.) to process the out-of-order scheduling. There is no benefit to support the described out-of-order scheduling in some scenarios. For example, a scenario when supporting out-of-order scheduling could be useful is when the UE supports URLLC (e.g., PDSCH B) and eMBB (e.g., PDSCH A) traffics simultaneously. Not supporting out-of-order scheduling in such scenario may penalize the URLLC traffic in terms of latency in an event that the eMBB traffic is already scheduled. Other than such scenario, there is no benefit to support the out-of-order scheduling.

In view of the above, the present disclosure proposes a number of schemes pertaining to handling out-of-order scheduling with respect to the UE and the network apparatus. According to the schemes of the present disclosure, the UE may not need to support the out-of-order scheduling. The UE may be not expected to receive or process the out-of-order scheduling grants. Alternatively, the out-of-order scheduling may be supported based on UE capabilities or by network configurations. Such design may simplify UE implementation, reduce power consumption, improve processing efficiency, etc.

When the out-of-order scheduling is not supported by the UE, the UE is not expected to receive or process out-of-order scheduling grants. For example, for any two hybrid automatic repeat request (HARQ) process identifications (IDs) in a given cell, in an event that the UE is scheduled to start receiving a PDSCH in symbol j by a PDCCH starting in symbol i, the UE is not expected to be scheduled to receive a PDSCH starting earlier than symbol j with a PDCCH staring later than symbol i. Specifically, after camping on a network node as a serving cell, the UE may be configured to receive a downlink control information (DCI) from the network node. The UE may be configured to detect whether an out-of-order scheduling is configured by the DCI. The UE may determine not to process the out-of-order scheduling in an event that the out-of-order scheduling is configured.

In some implementations, when the UE is not expected to receive the out-of-order scheduling, the UE may be configured to monitor the configured CORESET but ignore the DCI that indicates the out-of-order scheduling. Specifically, the UE may monitor the configured CORESET. The CORESET may comprise the scheduling DCI. The UE may detect whether the out-of-order scheduling is indicated by the scheduling DCI. In an event that the out-of-order scheduling is indicated by the scheduling DCI, the UE may be configured to ignore the scheduling DCI. For example, the UE may discard, delete, or not process the scheduling DCI. The UE may be configured not to receive the out-of-order PDSCH.

In some implementations, the UE may monitor the configured CORESET. The CORESET may comprise the scheduling DCI. The UE may decode the scheduling DCI. The UE is not expected to decode the corresponding PDSCH in an event that the out-of-order scheduling is indicated by the scheduling DCI. The UE may be configured to cancel the decoding of the PDSCH indicated by the DCI. For example, the UE may be configured not to receive, decode, process, or to ignore the PDSCH indicated by the scheduling DCI. The UE may further be configured to transmit a negative acknowledgement (NACK) corresponding to the ignored PDSCH to the network node.

In some implementations, the UE may monitor the configured CORESET. The CORESET may comprise the scheduling DCI. The UE may decode the scheduling DCI. The UE is not expected to decode the corresponding PDSCH in an event that the out-of-order scheduling is indicated by the scheduling DCI. The UE may be configured to cancel the decoding of the PDSCH indicated by the DCI. For example, the UE may be configured not to receive, decode, process, or to ignore the PDSCH indicated by the scheduling DCI. The UE is also not expected to transmit a NACK for the ignored PDSCH. The UE may be configured to cancel a transmission of a NACK corresponding to the ignored PDSCH to the network node.

In some implementations, when the UE is not expected to receive the out-of-order scheduling, the UE is also not expected to monitor the configured CORESET. The UE may be configured to cancel a monitoring of a CORESET of a PDCCH.

On the other hand, the out-of-order scheduling may be supported based on UE capabilities or by network configurations. Specifically, the UE may be configured to determine whether the out-of-order scheduling is supported. The UE may transmit a capability indication to the network node according to the determination result. The capability indication may be used to inform the network node whether the out-of-order scheduling is supported by the UE. The UE may further determine whether to process the out-of-order scheduling according to the determination result.

The out-of-order scheduling may be supported depending on UE capability. The UE capability may be defined per UE as a single capability parameter. The UE capability may also be defined per radio carrier. For example, the UE may be configured to receive the out-of-order scheduling in certain frequency bands.

Alternatively, the UE may be configured to support the out-of-order scheduling by network configurations. The UE may be explicitly configured to support the out-of-order scheduling. For example, the UE may be configured to receive a configuration from the network node. The configuration may comprise, for example and without limitations, a radio resource control (RRC) parameter to turn on/off the functionality to support the out-of-order scheduling. The UE may be configured to determine whether to support the out-of-order scheduling according to the configuration.

Alternatively, the out-of-order scheduling may be supported when the UE is expected to receive or transmit a high-priority transmission (e.g., URLLC). Specifically, the UE may be configured to determine whether a high-priority transmission is configured by the network node. The UE may determine whether to support the out-of-order scheduling according to the high-priority transmission. For example, the UE may determine to receive the out-of-order scheduling when the UE is configured by a higher layer (e.g., RRC layer) configuration (e.g., higher layer URLLC-specific radio bearers, quality of service (QoS), and so on). In another example, the UE may determine to receive the out-of-order scheduling when the UE is configured by a physical layer configuration (e.g., physical layer URLLC-specific DCI format, DCI field, modulation and coding scheme (MCS) table, and so on).

Alternatively, the out-of-order scheduling may be supported during a BWP switch process. Specifically, the UE may be configured to receive a BWP switch indication from the network node. The UE may determine whether to support the out-of-order scheduling according to the BWP switch indication. For example, in an event that the UE receives a scheduling DCI (e.g., DCI format 1_1) that indicates a BWP switch, the UE may be temporarily configured to receive the out-of-order scheduling PDSCH till the BWP switch is complete.

The above mentioned schemes may be applied when the out-of-order scheduling occurs within the same slot or across slots, or within the same slot and across slots. For example, the schemes of the present disclosure may be applied to scenarios 100 and 200. In addition, the above mentioned schemes may also be applied to different service types. For example, the above mentioned schemes may be applied when the out-of-order scheduling within a slot is not supported for the eMBB traffic. The above mentioned schemes may be applied when the out-of-order scheduling is not supported both within a slot and across slots for the eMBB traffic. The above mentioned schemes may be applied when the out-of-order scheduling within a slot is not supported both for the eMBB traffic and the URLLC traffic. The above mentioned schemes may be applied when the out-of-order scheduling within a slot and across slots is not supported both for the eMBB traffic and the URLLC traffic. The above mentioned schemes may be applied when the out-of-order scheduling is not supported for the eMBB traffic but is supported for the URLLC traffic. The above mentioned schemes may be applied when the out-of-order scheduling is not supported for the eMBB traffic but is supported for the URLLC traffic and the PDCCH scheduling URLLC will cancel any future eMBB PDSCH scheduled previously.

### Illustrative Implementations

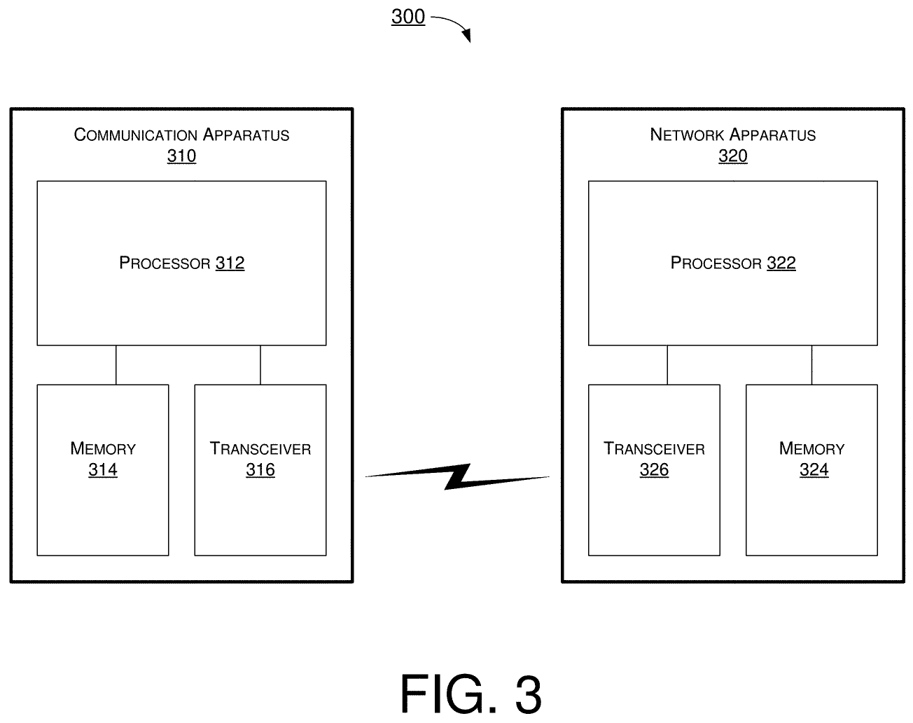

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to handling out-of-order scheduling with respect to user equipment and network apparatus in wireless communications, including schemes described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more RISC or CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, when the out-of-order scheduling is not supported by processor 312, processor 312 is not expected to receive or process out-of-order scheduling grants. For example, for any two HARQ process IDs in a given cell, in an event that processor 312 is scheduled to start receiving a PDSCH in symbol j by a PDCCH starting in symbol i, processor 312 is not expected to be scheduled to receive a PDSCH starting earlier than symbol j with a PDCCH staring later than symbol i. Specifically, after camping on network apparatus 320 as a serving cell, processor 312 may be configured to receive, via transceiver 316, a DCI from network apparatus 320. Processor 312 may be configured to detect whether an out-of-order scheduling is configured by the DCI. Processor 312 may determine not to process the out-of-order scheduling in an event that the out-of-order scheduling is configured.

In some implementations, when processor 312 is not expected to receive the out-of-order scheduling, processor 312 may be configured to monitor the configured CORESET but ignore the DCI that indicates the out-of-order scheduling. Specifically, processor 312 may monitor, via transceiver 316, the configured CORESET. The CORESET may comprise the scheduling DCI. Processor 312 may detect whether the out-of-order scheduling is indicated by the scheduling DCI. In an event that the out-of-order scheduling is indicated by the scheduling DCI, processor 312 may be configured to ignore the scheduling DCI. For example, processor 312 may discard, delete, or not process the scheduling DCI. Processor 312 may be configured not to receive the out-of-order PDSCH.

In some implementations, processor 312 may monitor, via transceiver 316, the configured CORESET. The CORESET may comprise the scheduling DCI. Processor 312 may decode the scheduling DCI. Processor 312 is not expected to decode the corresponding PDSCH in an event that the out-of-order scheduling is indicated by the scheduling DCI. Processor 312 may be configured to cancel the decoding of the PDSCH indicated by the DCI. For example, processor 312 may be configured not to receive, decode, process, or to ignore the PDSCH indicated by the scheduling DCI. Processor 312 may further be configured to transmit, via transceiver 316, a NACK corresponding to the ignored PDSCH to network apparatus 320.

In some implementations, processor 312 may monitor, via transceiver 316, the configured CORESET. The CORESET may comprise the scheduling DCI. Processor 312 may decode the scheduling DCI. Processor 312 is not expected to decode the corresponding PDSCH in an event that the out-of-order scheduling is indicated by the scheduling DCI. Processor 312 may be configured to cancel the decoding of the PDSCH indicated by the DCI. For example, processor 312 may be configured not to receive, decode, process, or to ignore the PDSCH indicated by the scheduling DCI. Processor 312 is also not expected to transmit a NACK for the ignored PDSCH. Processor 312 may be configured to cancel a transmission of a NACK corresponding to the ignored PDSCH to network apparatus 320.

In some implementations, when processor 312 is not expected to receive the out-of-order scheduling, processor 312 is also not expected to monitor the configured CORESET. Processor 312 may be configured to cancel a monitoring of a CORESET of a PDCCH.

In some implementations, the out-of-order scheduling may be supported based on communication apparatus capabilities or by network configurations. Specifically, processor 312 may be configured to determine whether the out-of-order scheduling is supported. Processor 312 may transmit, via transceiver 316, a capability indication to network apparatus 320 according to the determination result. Processor 312 may use the capability indication to inform network apparatus 320 whether the out-of-order scheduling is supported by communication apparatus 310. Processor 312 may further determine whether to process the out-of-order scheduling according to the determination result.

In some implementations, processor 312 may be configured to support the out-of-order scheduling by network configurations. Processor 312 may be explicitly configured to support the out-of-order scheduling. For example, processor 312 may be configured to receive a configuration from network apparatus 320. The configuration may comprise, for example and without limitations, an RRC parameter to turn on/off the functionality to support the out-of-order scheduling. Processor 312 may be configured to determine whether to support the out-of-order scheduling according to the configuration.

In some implementations, the out-of-order scheduling may be supported when processor 312 is expected to receive or transmit a high-priority transmission (e.g., URLLC). Specifically, processor 312 may be configured to determine whether a high-priority transmission is configured by network apparatus 320. Processor 312 may determine whether to support the out-of-order scheduling according to the high-priority transmission. For example, processor 312 may determine to receive the out-of-order scheduling when processor 312 is configured by a higher layer (e.g., RRC layer) configuration (e.g., higher layer URLLC-specific radio bearers, QoS, etc.). In another example, processor 312 may determine to receive the out-of-order scheduling when processor 312 is configured by a physical layer configuration (e.g., physical layer URLLC-specific DCI format, DCI field, MCS table, etc.).

In some implementations, processor 312 may be configured to receive a BWP switch indication from network apparatus 320. Processor 312 may determine whether to support the out-of-order scheduling according to the BWP switch indication. For example, in an event that processor 312 receives a scheduling DCI (e.g., DCI format 1_1) that indicates a BWP switch, processor 312 may be temporarily configured to receive the out-of-order scheduling PDSCH till the BWP switch is complete.

### Illustrative Processes

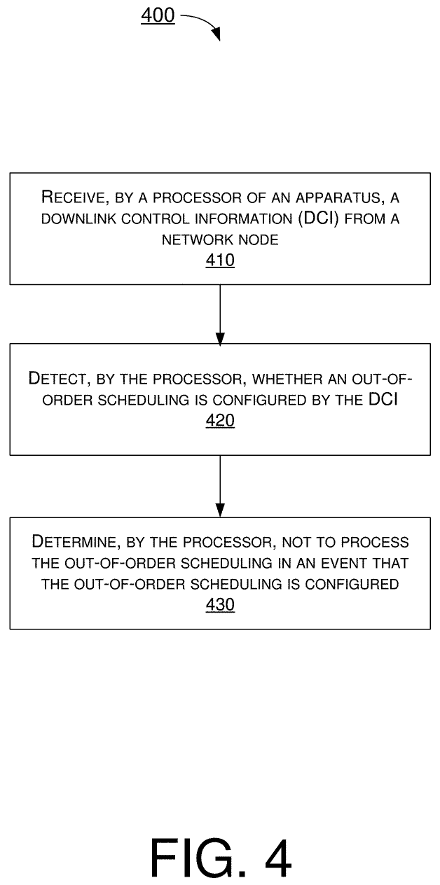

FIG. 4 illustrates an example process 400 in accordance with an implementation of the present disclosure. Process 400 may be an example implementation of above scenarios, whether partially or completely, with respect to handling out-of-order scheduling with the present disclosure. Process 400 may represent an aspect of implementation of features of communication apparatus 310 and/or network apparatus 320. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 and/or network apparatus 320 or any suitable UE, network node or machine type devices. Solely for illustrative purposes and without limitation, process 400 is described below in the context of communication apparatus 310. Process 400 may begin at block 410.

At 410, process 400 may involve processor 312 of apparatus 310 receiving a DCI from a network node. Process 400 may proceed from 410 to 420.

At 420, process 400 may involve processor 312 detecting whether an out-of-order scheduling is configured by the DCI. Process 400 may proceed from 420 to 430.

At 430, process 400 may involve processor 312 determining not to process the out-of-order scheduling in an event that the out-of-order scheduling is configured.

In some implementations, process 400 may involve processor 312 ignoring the DCI in an event that the out-of-order scheduling is configured by the DCI.

In some implementations, process 400 may involve processor 312 decoding the DCI. Process 400 may also involve processor 312 cancelling a decoding of a PDSCH indicated by the DCI. Process 400 may further involve processor 312 transmitting a NACK corresponding to the PDSCH to the network node.

In some implementations, process 400 may involve processor 312 decoding the DCI. Process 400 may also involve processor 312 cancelling a decoding of a PDSCH indicated by the DCI. Process 400 may further involve processor 312 cancelling a transmission of a NACK corresponding to the PDSCH to the network node.

In some implementations, process 400 may involve processor 312 cancelling a monitoring of a CORESET of a PDCCH.

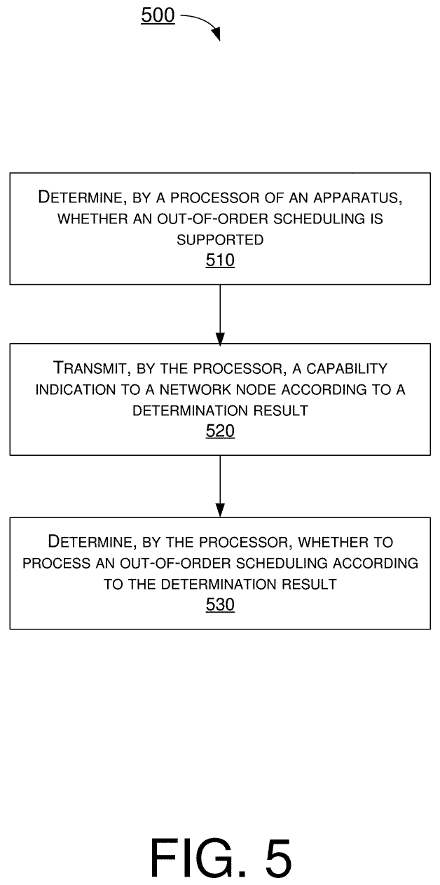

FIG. 5 illustrates an example process 500 in accordance with an implementation of the present disclosure. Process 500 may be an example implementation of above scenarios, whether partially or completely, with respect to handling out-of-order scheduling with the present disclosure. Process 500 may represent an aspect of implementation of features of communication apparatus 310 and/or network apparatus 320. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 310 and/or network apparatus 320 or any suitable UE, network node or machine type devices. Solely for illustrative purposes and without limitation, process 500 is described below in the context of communication apparatus 310. Process 500 may begin at block 510.

At 510, process 500 may involve processor 312 of apparatus 310 determining whether an out-of-order scheduling is supported. Process 500 may proceed from 510 to 520.

At 520, process 500 may involve processor 312 transmitting a capability indication to a network node according to a determination result. Process 500 may proceed from 520 to 530.

At 530, process 500 may involve processor 312 determining whether to process an out-of-order scheduling according to the determination result.

In some implementations, process 500 may involve processor 312 receiving a configuration from the network node. Process 500 may further involve processor 312 determining whether to support the out-of-order scheduling according to the configuration.

In some implementations, process 500 may involve processor 312 determining whether a high-priority transmission is configured by the network node. Process 500 may further involve processor 312 determining whether to support the out-of-order scheduling according to the high-priority transmission.

In some implementations, process 500 may involve processor 312 determining whether the high-priority transmission is configured via a higher layer configuration or a physical layer configuration.

In some implementations, process 500 may involve processor 312 receiving a BWP switch indication from the network node. Process 500 may further involve processor 312 determining whether to support the out-of-order scheduling according to the BWP switch indication.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink control information (DCI) from a network node;
detecting, by the processor, whether an out-of-order scheduling is configured by the DCI; and
determining, by the processor, not to process the out-of-order scheduling in an event that the out-of-order scheduling is configured.

2. The method of claim 1, wherein the determining comprises:
ignoring the DCI in an event that the out-of-order scheduling is configured by the DCI.

3. The method of claim 1, wherein the determining comprises:
decoding the DCI;
cancelling a decoding of a physical downlink shared channel (PDSCH) indicated by the DCI; and
transmitting a negative acknowledgement (NACK) corresponding to the PDSCH to the network node.

4. The method of claim 1, wherein the determining comprises:
decoding the DCI;
cancelling a decoding of a physical downlink shared channel (PDSCH) indicated by the DCI; and
cancelling a transmission of a negative acknowledgement (NACK) corresponding to the PDSCH to the network node.

5. The method of claim 1, further comprising:
cancelling, by the processor, a monitoring of a control resource set (CORESET) of a physical downlink control channel (PDCCH).

6. A method, comprising:
determining, by a processor of an apparatus, whether an out-of-order scheduling is supported;
transmitting, by the processor, a capability indication to a network node according to a determination result; and
determining, by the processor, whether to process an out-of-order scheduling according to the determination result.

7. The method of claim 6, further comprising:
receiving, by the processor, a configuration from the network node; and
determining, by the processor, whether to support the out-of-order scheduling according to the configuration.

8. The method of claim 6, further comprising:
determining, by the processor, whether a high-priority transmission is configured by the network node; and
determining, by the processor, whether to support the out-of-order scheduling according to the high-priority transmission.

9. The method of claim 8, wherein the determining of whether the high-priority transmission is configured by the network node comprises determining whether the high-priority transmission is configured via a higher layer configuration or a physical layer configuration.

10. The method of claim 6, further comprising:
receiving, by the processor, a bandwidth part (BWP) switch indication from the network node; and
determining, by the processor, whether to support the out-of-order scheduling according to the BWP switch indication.

11. An apparatus, comprising:
a transceiver capable of wirelessly communicating with a network node of a wireless network; and
a processor communicatively coupled to the transceiver, the processor capable of:
receiving, via the transceiver, a downlink control information (DCI) from a network node;
detecting whether an out-of-order scheduling is configured by the DCI; and
determining not to process the out-of-order scheduling in an event that the out-of-order scheduling is configured.

12. The apparatus of claim 11, wherein, in determining not to process the out-of-order scheduling, the processor is capable of:
ignoring the DCI in an event that the out-of-order scheduling is configured by the DCI.

13. The apparatus of claim 11, wherein, in determining not to process the out-of-order scheduling, the processor is capable of:
decoding the DCI;
cancelling a decoding of a physical downlink shared channel (PDSCH) indicated by the DCI; and
transmitting, via the transceiver, a negative acknowledgement (NACK) corresponding to the PDSCH to the network node.

14. The apparatus of claim 11, wherein, in determining not to process the out-of-order scheduling, the processor is capable of:
decoding the DCI;
cancelling a decoding of a physical downlink shared channel (PDSCH) indicated by the DCI; and
cancelling a transmission of a negative acknowledgement (NACK) corresponding to the PDSCH to the network node.

15. The apparatus of claim 11, wherein the processor is further capable of:
cancelling a monitoring of a control resource set (CORESET) of a physical downlink control channel (PDCCH).

16. An apparatus, comprising:
a transceiver capable of wirelessly communicating with a network node of a wireless network; and
a processor communicatively coupled to the transceiver, the processor capable of:
determining whether an out-of-order scheduling is supported;
transmitting, via the transceiver, a capability indication to a network node according to a determination result; and
determining whether to process an out-of-order scheduling according to the determination result.

17. The apparatus of claim 16, wherein the processor is further capable of:
receiving, via the transceiver, a configuration from the network node; and
determining whether to support the out-of-order scheduling according to the configuration.

18. The apparatus of claim 16, wherein the processor is further capable of:
determining whether a high-priority transmission is configured by the network node; and
determining whether to support the out-of-order scheduling according to the high-priority transmission.

19. The apparatus of claim 18, wherein, in determining whether a high-priority transmission is configured by the network node, the processor is capable of:
determining whether the high-priority transmission is configured via a higher layer configuration or a physical layer configuration.

20. The apparatus of claim 16, wherein the processor is further capable of:
receiving, via the transceiver, a bandwidth part (BWP) switch indication from the network node; and
determining whether to support the out-of-order scheduling according to the BWP switch indication.
